(19) United States
(12) Patent Application Publication
(10) Pub. No.: US 2014/0059055 A1
(43) Pub. Date: Feb. 27, 2014

(54) System and Method for Combining Multiple Recommender Systems

(71) Applicant: OPERA SOLUTIONS, LLC, Jercey City, NJ (US)

(72) Inventors: Abhikesh Nag, San Diego, CA (US); William J.J. Roberts, Rockville, MD (US); Jacob Spoelstra, Carlsbad, CA (US)

(73) Assignee: OPERA SOLUTIONS, LLC, Jercey City, NJ (US)

(21) Appl. No.: 14/011,324

(22) Filed: Aug. 27, 2013

Related U.S. Application Data
(60) Provisional application No. 61/693,563, filed on Aug. 27, 2012.

(51) Int. Cl. G06F 17/30

(52) U.S. Cl. CPC G06F 17/30386
USPC 707/748

(57) ABSTRACT

A system and method for recommending items to a user is provided. The system could combine recommendations provided by multiple recommenders by: a) calculating for each recommender j a maximum score Pⱼ for the recommended n items as a function (e.g., sum) of stored recommender ratings for the n items, b) calculating a minimum acceptable score for each recommender system j as a function of the maximum score Pⱼ and a predetermined tradeoff factor αⱼ such that the minimum acceptable score for at least one recommender system j is less than the maximum score Pⱼ, c) selecting at least one set of items from the plurality of items, such that scores Pⱼ (and/or sum of scores Pⱼ) calculated for the selected set of items for each recommender system j are greater than the respective minimum acceptable score for that recommender system j, and d) identifying selected set of items to the user.

### CROSS-REFERENCE TO RELATED APPLICATIONS

This application claims the benefit of U.S. Provisional Application Ser. No. 61/693,563 filed on Aug. 27, 2012, the entire disclosure of which is expressly incorporated herein by reference.

### TECHNICAL FIELD

This disclosure relates to a computer-based system and method for combining recommendations from a plurality of recommender systems to provide a single set of recommendations subject to item-specific business rules, constraints, and/or metrics.

### BACKGROUND

A recommender system can be used to estimate the likelihood that a specific user will pick specific items from a plurality of items based on past choices. Consider a plurality of recommender systems (e.g., recommenders) where each relies on different criteria to produce different recommendations. In many cases, a user may be provided with a better overall recommendation by incorporating the different recommendations of the different recommender systems into a single recommender system.

Linear regression is one potential model or method to combine the recommendations of different recommender systems. In the linear regression model, the outputs of the recommender systems are the dependent variables and the coefficients are learned in a training step. The disadvantage to such a model is that it requires training data and a training step. Furthermore, since this is a statically trained model, there is no way of updating the coefficients in a dynamic, adaptive environment (e.g., periodically re-trained), and as a result the model could suffer from performance degradation over time.

In addition to recommender ratings, other considerations may need to be taken into account in providing final recommendations. In particular, a firm or organization employing a recommender system may desire to introduce certain rules for recommendations. For example, a cable company recommending movies to users may want to recommend Academy Award-winning movies during the week of the Academy Awards, or a department store may want to recommend holiday goods during Christmas week. Manual applications of such rules could effectively override the selections made by the system and result in recommendations that a user may not like. In addition to specific rules or constraints, a firm may want to apply certain metrics to be considered in optimizing the recommendations. For example, a firm may want to, simultaneously, maximize the total revenue associated with the recommendations of the recommender system, ensure that consumer satisfaction is maintained above a certain pre-determined level, and/or maintain adequate levels of inventory.

Thus, a need exists to combine the outputs of different recommendation systems while satisfying business goals and constraints without requiring training data or manually overriding system recommendations.

### SUMMARY

The present disclosure provides a system and method for recommending items to a user. The system could combine recommendations provided by multiple recommenders by: a) calculating for each recommender j a maximum score Pⱼ for the recommended n items as a function (e.g., sum) of stored recommender ratings for the n items, b) calculating a minimum acceptable score for each recommender system j as a function of the maximum score Pⱼ and a predetermined tradeoff factor αⱼ such that the minimum acceptable score for at least one recommender system j is less than the maximum score Pⱼ, c) selecting at least one set of items from the plurality of items, such that scores Pⱼ (and/or sum of scores Pⱼ) calculated for the selected set of items for each recommender system j are greater than the respective minimum acceptable score for that recommender system j, and d) identifying selected set of items to the user.

### BRIEF DESCRIPTION OF THE DRAWING

A more complete understanding of the present disclosure may be realized by reference to the accompanying drawing in which:

FIG. 1 is a schematic drawing depicting a recommender system of the present disclosure;

FIG. 2 is a schematic drawing depicting the operation of an optimizer module implemented by the system of FIG. 1;

FIG. 3 is a flow chart depicting steps for combining the outputs of different recommender systems;

FIG. 4 is a table illustrating aspects of the steps illustrated in FIG. 3; and

FIG. 5 is a schematic diagram of a representative computer system for implementing the system of the present disclosure.

### DESCRIPTION

The present disclosure is directed to a computer-based system and method for combining scores from a plurality of recommender systems (e.g., Recommenders). In addition to combining multiple recommender systems, the system (e.g., Recommendation Combination System) could incorporate and process (in a principled manner) business rules, constraints, and/or editorial content/decisions in a single unified recommender framework. The inclusion of certain rules that recommendations must conform to and certain metrics the firm may want to apply while optimizing the recommendations, better accounts for the business objectives of a provider firm. The system and method disclosed herein alleviate disadvantages associated with the prior art, such as the need for obtaining training data and including a training step (such as required by models employing linear regression methods), and performance degradation (such as when retraining steps are infrequently performed).

More specifically, the system could recommend a predetermined number of a plurality of items by combining outputs from any number of distinct recommender systems trained with implicit and/or explicit data, and/or other types of data. A “consumed recommender” is a recommender system trained on implicit ratings, where implicit data is obtained by an act of consuming an item (e.g. visiting a webpage, watching a movie, buying an item from a store, etc.). A “liked recommender” is a recommender system trained on explicit ratings data, where explicit data could be a rating (e.g., score) given explicitly by a user (e.g., five-star based rating of movies, explicit “yes” or “no” rating on surveys, etc.). The combination step of the Recommendation Combination System does not rely on heuristic data manipulations and could be performed using linear programming or any other suitable type of programming (e.g., goal programming and multi objective optimization).

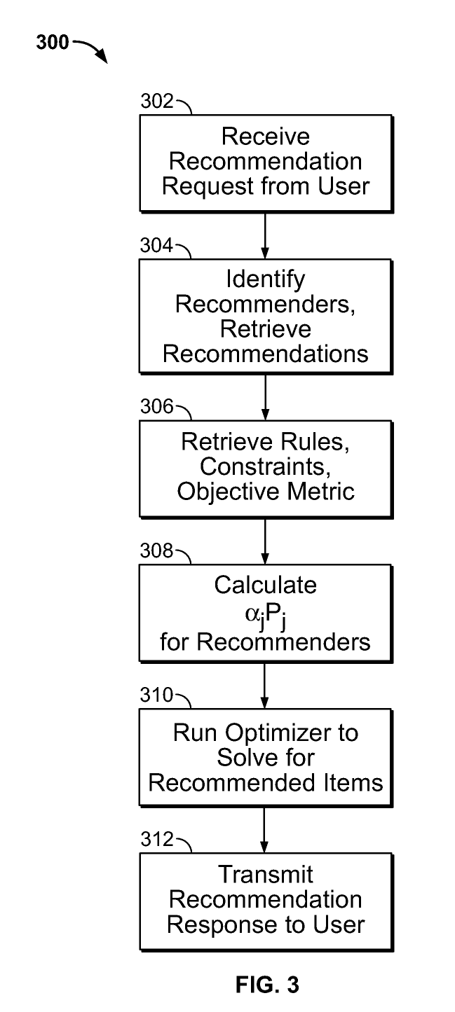

As discussed in more detail below in connection with FIG. 3, the system and method could include the steps of: a) receiving a request transmitted over a network by a user, the request identifying a desired number n of items to be recommended among the plurality of items, b) retrieving (e.g., transmitting a request and receiving a response) ratings for a plurality of items (e.g., a scored list) from each of a plurality of recommenders j, c) calculating for each recommender j a maximum score Pⱼ for the recommended items as a function of the retrieved ratings, d) calculating a minimum acceptable score (e.g., threshold) for each recommender system j as a function of the maximum score Pⱼ and a predetermined tradeoff factor αⱼ such that the minimum acceptable score for at least one recommender system j is less than the maximum score Pⱼ, d) selecting at least one set of items from the plurality of items, such that scores Pⱼ calculated for the selected set of items for each recommender j are greater than the respective minimum acceptable score for that recommender j, and e) transmitting a response over the network to the user identifying the selected set of items.

In other words, an optimization module of the system calculates a maximum score for each recommender system that corresponds to the best unconstrained ranking of items from that individual recommender system, and calculates a minimum value (e.g., threshold value) by multiplying the maximum score by a tradeoff factor. The optimization module produces a single (re)ranking of the items of the plurality of recommenders (e.g., optimized list) such that one or more functions (of the scores of each of the individual recommenders) is maximized subject to one or more constraints (e.g., that the individual recommender scores that correspond to the (re)ranking is at least (or greater than) a minimum value associated with each of the recommender systems). Thereby, each recommended item of the optimized list is calculated by the optimization module using the maximum score, minimum score, and tradeoff factors. In this way, for example, the system ensures that (re)ranking items by those a user will like and consume, the system will not recommend an item the user will not like, even if that item has a high probability of being consumed.

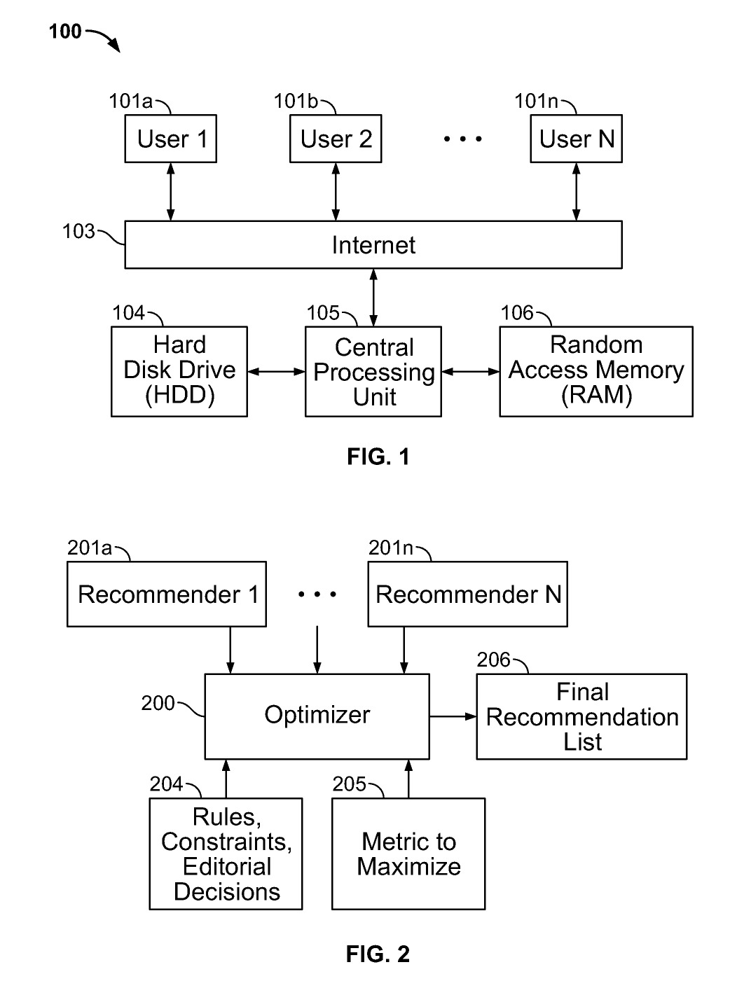

FIG. 1 depicts a recommender system 100 of the present disclosure. The system 100 includes network connections via the Internet 103 to users 101a, 101b, . . . 101n. A Central Processing Unit (CPU) 105 could retrieve and store data to and from one or more of a Hard Disk Drive (HDD) 104 and a Random Access Memory (RAM) 106. It will be appreciated by those skilled in the art that any flow charts, flow diagrams, state transition diagrams, pseudo code, etc. represent various processes which could be stored in a computer readable medium and so executed by a computer or processor. Software modules, or simply modules which are implied to be software, could be represented herein as any combination of flowchart elements or other elements indicating performance of process steps and/or textual description. Such modules could be executed by hardware that is expressly or implicitly shown.

FIG. 2 depicts the operation of an optimizer module 200 implemented by the system 100 (see FIG. 1). The optimizer module 200 could be implemented by software stored on the HDD 104 (see FIG. 1) and loadable by the CPU 105 onto the RAM 106 for execution. In operation, upon receipt by the CPU 105 of a request for recommendations from one of the users 101a, 101b, . . . 101n, the CPU 105 invokes the optimizer module 200. To fulfill the user request, the optimizer module 200 could access recommendations provided by recommender 201a, . . . 201n, business rules 204, and business objective functions 205, and produce a final recommendation list 206. Details regarding the functionality of the optimizer module 200 are provided as follows.

Two Recommender System

The Recommendation Combination System could be a simplified two recommender system incorporating “liked” and “consumed” recommendation models (as discussed above). For a particular user, let p_{i,j} be the score for the i^{th} item from the j^{th} recommender. Let xᵢ be the combined score for the i^{th} item. In general, the method and apparatus fuses {p_{i,j}ε [symbol] , i=1, . . . , N, j=1, . . . , J} into a single set of recommendations {xᵢε [symbol] , i=1, . . . , N} where there are a total of N items and J recommenders.

Let J=2, and let {_{i,cons}ε [symbol] , i=1, . . . , N) represent N variables that are proportional to the probability that a particular user consumed the i^{th} item. Let {p_{i,like}ε [symbol] , i=1, . . . , N) represent N variables that are proportional to the amount a particular user liked the i^{th} item, where there are N items for a consumer to choose. In the baseline system, the items corresponding to the n largest values of {P_{i,cons}} are chosen. This is equivalent to finding {xᵢε{0, 1}, i=1, . . . , N} that

$${maximize}_{{x}_{i}} P = {\sum }_{i - 1}^{N} {p}_{i , cons} {x}_{i} \\ subject to \\ n = {\sum }_{i - 1}^{N} {x}_{i} . \qquad ( 1 )$$

The goal is to find the n items that simultaneously maximize both the probability that the item will be consumed by the user and the degree that the item will be liked by the user. Into this process, the system incorporates the probability that the item was consumed by the user (and/or other users) and the degree that the item was liked by the user (and/or other users).

The problem could be formulated as a linear programming problem, a goal programming problem, and/or a multiobjective programming problem. To consider the degree to which items were liked as part of the recommendation method, a slight loss is assumed in the total probability P from Equation 1 that the item was consumed. Effectively, this loss can be traded for an increase in the amount that the item was liked. This trade-off parameter is denoted by α, where {αε [symbol] , 0≦α≦1}. In the most general case, {xᵢε [symbol] }, but {xᵢε{0, 1}} and {xᵢε[0, 1]} could also be used, among others. The optimization problem can now can be formulated as finding {xᵢε[0, 1]} or {xᵢε{0, 1}} that

$${maximize}_{{x}_{i}} {\sum }_{i = 1}^{N} {p}_{i , like} {x}_{i} \\ subject to \\ {\sum }_{i = 1}^{N} {p}_{i , cons} {x}_{i} \geq α P \\ n = {\sum }_{i = 1}^{N} {x}_{i} \\ 0 \leq α \leq 1. \qquad ( 2 )$$

In the case where {xᵢε[0, 1]}, the solution to the optimization problem of Equation 2, xᵢ, is sorted and the top n values are selected and transmitted as recommendations to the user. A commonly used open-source C library, GNU Linear Programming KIT (GLPK) could be used to solve the linear program. In the case where {xᵢ.ε{0, 1}}, the n items to be recommended to the user are the ones for which xᵢ=1.

Adding Rules/Constraints

To introduce rules into the framework, let Rₖ be the k^{th} rule that informs the optimizer which items are allowed, where there are N items and K rules. Let r_{i,k} be a binary indicator variable that informs the optimizer if the i^{th} item is allowed into the recommendation list and nₖ is the number of items that want to be included in the recommendation list that follow the k^{th} rule, {Rₖ: r_{i,k}ε{0, 1}, i=1, . . . , N, k=1, . . . , K}. The following constraints are added to the optimization problem of Equation 2:

$${n}_{k} = {\sum }_{i = 1}^{N} {r}_{i , k} {x}_{i} , k = 1 , … , K \qquad ( 3 )$$

In the case where {xᵢε[0, 1]}, the solution to the optimization problem of Equation 3, xᵢ, is sorted and the top n values are selected and transmitted as recommendations to the user. In the case where {xᵢε{0, 1}}, the items to be recommended to the user are the ones for which xᵢ=1. These recommendations combine scores from two different recommenders as well as incorporate the rules and constraints.

Adding Alternate Metric for Objective Function

The system could select at least one set of items subject to maximizing an objective function. A user could choose from multiple objective functions while solving the optimization problem (e.g., maximize the revenue or profits earned from different items). In this way, the system could predict items that a consumer will like and consume, and at the same time maximize revenue for the firm.

To introduce an alternate metric important to a firm/organization, the metric should be considered to be some function of the i^{th} item. Let {ƒ(i)ε [symbol] , i=1, . . . , N) be some metric important to the firm (e.g., revenue). The optimization problem now reduces to finding {xᵢε[0, 1]} or {xᵢε{0, 1}} with the same constraints as Equation 3 but with a new objective function:

$${maximize}_{{x}_{i}} {\sum }_{i = 1}^{N} f ( i ) {x}_{i} \qquad ( 4 )$$

In the case where {xᵢε[0, 1]}, the solution xᵢ is sorted and the top n items are the final recommendations transmitted to the user. In the case where {xᵢε{0, 1}}, the items that are to be recommended to the user are the ones for which xᵢ=1. This xᵢ is the final answer which combines the liked and watched model scores, incorporates the rules formulated by the firm, and uses the metric that is important to the firm.

The structure of Equation 4 is abstract and flexible and is applicable to many different metrics. Alternatively, ƒ(i) used in Equation 4 could be the following:

ƒ(i)=β_{cons}p_{i,cons}+βₗᵢₖₑp_{i,like} (5)

The function of each item, ƒ(i), is a linear combination of the output of liked and consumed recommenders. Note that this linear combination could be used in the objective function. Here, β_{cons},βₗᵢₖₑβ [symbol] are design parameters chosen by the system designer based on operating conditions.

The potential benefit achieved from applying an alternate metric for the objective function can be illustrated by the following examples. Consider a large retail store that carries similar items with different profit margins. It is in the store's pecuniary interest to promote the item with the highest margin (everything else remaining the same and assuming they are similar items). In this case, ƒ(i) could be formulated to represent the profit margin for item i, such that if the base recommender has in its list two similar products with different profit margins, the final list will tend to select the recommendation with the higher profit margin.

In another example, consider a retailer experiencing a very large volume of sales due to seasonality (e.g., holiday season) or some other reason. The retailer would like to promote lesser selling items, and thereby minimize the recommendation of items that are low on stock. In this case, a weighted function ƒ(i) can be formulated for each item i, where the low-selling goods have a high weight and the high-selling goods have a low weight. The optimization will then tend to recommend the lesser selling items. Of course, recommendations will still tend to be directed to items that are deemed by the system as likely to be consumed by the user.

Extended to J Recommenders

For the system to include any number of recommenders, J=2 recommenders is extended to J>2 recommenders. With a total of J recommenders, the following constraints are added to the problem defined by Equation 4:

$${\sum }_{i = 1}^{N} {p}_{i , j} {x}_{i} \geq {α}_{j} {P}_{j} , j = 1 , … , J \\ {n}_{k} = {\sum }_{i = 1}^{N} {r}_{i , k} {x}_{i} , k = 1 , … , K \\ 0 \leq {α}_{j} \leq 1 , j = 1 , … , J . \qquad ( 6 )$$

Here, Pⱼ symbolizes the optimal (maximum) sum of scores from the j^{th} recommender. In other words, if the top n scores from the j^{th} recommender are sorted to get p_{i,j}^{sorted} where {ε [symbol] , i=1, . . . , n, j=1, . . . , J}, then Pⱼ=Σⁿᵢ₌₁ p_{i,j}^{sorted}. There is an αⱼ associated with the j^{th} recommender, which is a design parameter selected by the system designer based on operating conditions.

FIG. 3 provides a flow chart illustrating the operation of an optimizer module 200 (see FIG. 2). In step 302, the system electronically receives a recommendation request from one or more of a plurality of users 101a, . . . 101n (see FIG. 1). The request could be transmitted via the Internet 101 for receipt by the CPU 105 (see FIG. 1). The recommendation request could include information identifying one or more of a type, category and/or sub-category of item(s) to be recommended (e.g., the category “movies” has a sub-category “1950's science fiction”), and/or a number of items n to be recommended. Item types could include groceries, movies, television programs, printed publications, e-books, CDs, DVDs, retail goods, online goods, entertainment content, etc.

In step 304, the system identifies recommender systems (e.g., Recommenders) and electronically requests and/or retrieves the recommendations (e.g., scored lists) of the recommender systems. The system could retrieve one or more rules from a rules base stored in the memory, wherein the rules could be applied to identify, from the plurality of items, eligible items for selection in at least one set of items. The CPU 105 could search the HDD 104 to identify, based on predetermined criteria, recommender systems to provide recommendations to fulfill the request. For example, candidate recommender systems could be sorted according to an experience rating for the item type (and/or category) and/or by demographic information of the user (e.g., country/region, age, etc.). Further, the user (and/or system) could select a specific number of recommender systems as well as particular recommender systems (e.g., in the recommendation request), such as by affiliation (e.g., “other Netflix reviewers,” “Amazon reviewers,” etc.). The specified number could be selected (or re-selected) by a variety of means (e.g., including randomly, by frequency of previous selection, by date of last selection, etc.), such as if the specified number of highest-scoring recommender systems is exceeded.

In step 306, the system retrieves rules, constraints and/or objective metrics. The CPU 105 could retrieve additional information from the HDD 104 and/or RAM 106 relating to business rules, constraints, and/or the objective metric to be optimized. For example, according to particular business objectives, the rules and/or constraints could eliminate certain items from consideration, and the objective metric could be selected to promote the recommendation of certain items.

In step 308, the system calculates αⱼPⱼ for recommender systems (e.g., Recommenders). As discussed above, providing recommendations based on multiple recommender systems is facilitated by incorporating a trade-off parameter αⱼ, which is used in constraints applied to at least some recommender systems to allow some deviation from achieving a maximum scoring Pⱼ for the recommender system j in order to find a feasible result. At step 308, constraints αⱼPⱼ are calculated for the affected recommenders.

After the rules and constraints have been identified and/or calculated, in step 310, the system runs an optimizer module to identify (e.g., solve for) recommended items. In step 312, the system transmits the recommendation response containing the identified recommendations to the user. The recommendation response identifying the selected items could be prepared by the CPU 105 (see FIG. 1) and transmitted to the user over the Internet 103.

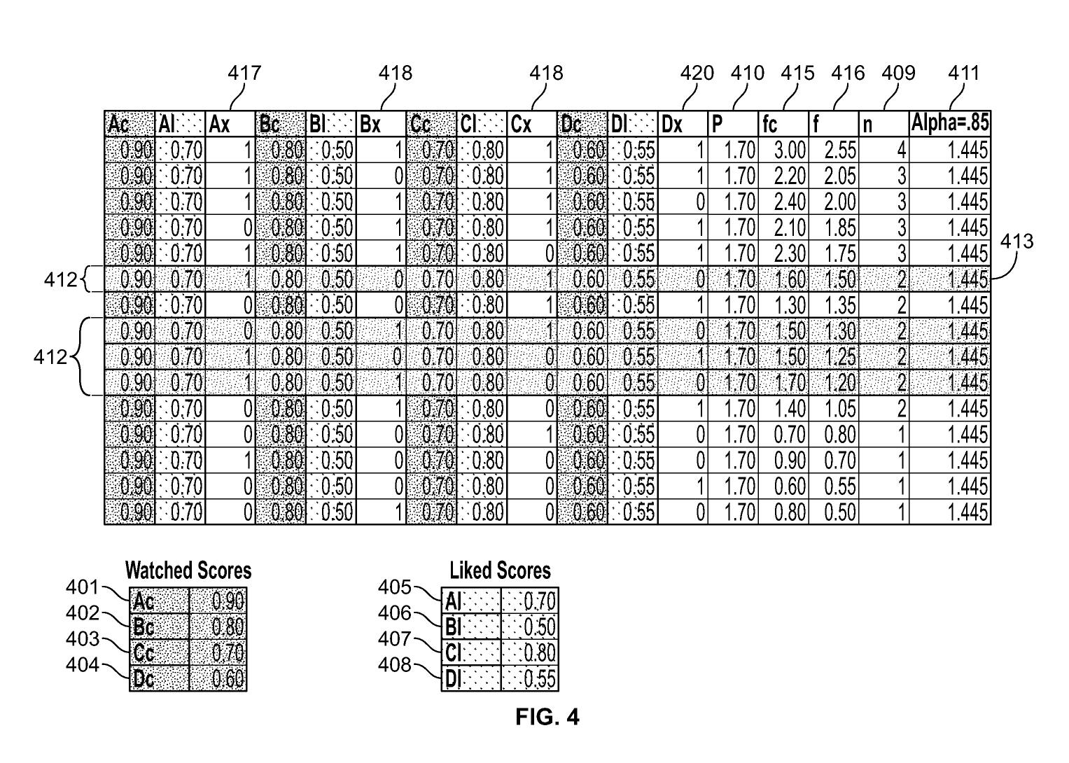

FIG. 4 is a table illustrating an example recommendation request. In this example, the items to be selected are movies, although there are many other items and media for which recommender systems could be used to recommend items for user selection (e.g., books, television shows, grocery items, and/or other consumable items). In this example request, an item type of “movie” has been selected, the number of items to be recommended is 2, and two recommender systems (e.g., Recommenders) have been selected. More specifically, the two recommender systems include a first recommender system providing recommendation scores, or “watched scores” 401-404, based on movies watched by viewers subscribing to a movie service, and a second recommender system providing recommendation scores, or “liked scores” 405-408, based on movie evaluations provided by viewers of the service. The scores could be retrieved by the CPU 105 from the HDD 104 (see FIG. 1). Each set of scores 401-404, 405-408 relates to movies A-D, the items under consideration have been limited to the movies A-D, and the objective metric is selected to maximize the sum of the liked scores. Each of the possible two-item pairings for the items A-D is evaluated.

P_{c} is the sum of highest 2 watched scores (e.g., the sum of scores A_{c} 401 and C_{c} 403, which total P_{c} 410, which is equal to 1.7), and α_{c}=0.85. As a result, the constrained sum for the watched scores of the two items to be selected is α_{c}P_{c} 411, which is equal to 1.445. Each row represents resulting values for the sum of watched scores 415 and the sum of liked scores 416, according to a number of selected items 409. Rows 412 show the results when the number of selected items is equal to 2, with columns 417-420 indicating the selected items by row with a cell entry of “1.” Because row 413 and rows 412 satisfy the watched scores constraint (e.g., the sum of watched scores 415 for the two selected items at 1.6 exceeds the constraint 411 of 1.445) and results in a highest sum of liked scores 416 for the two selected items at 1.5, the two items selected in row 413 are optimal.

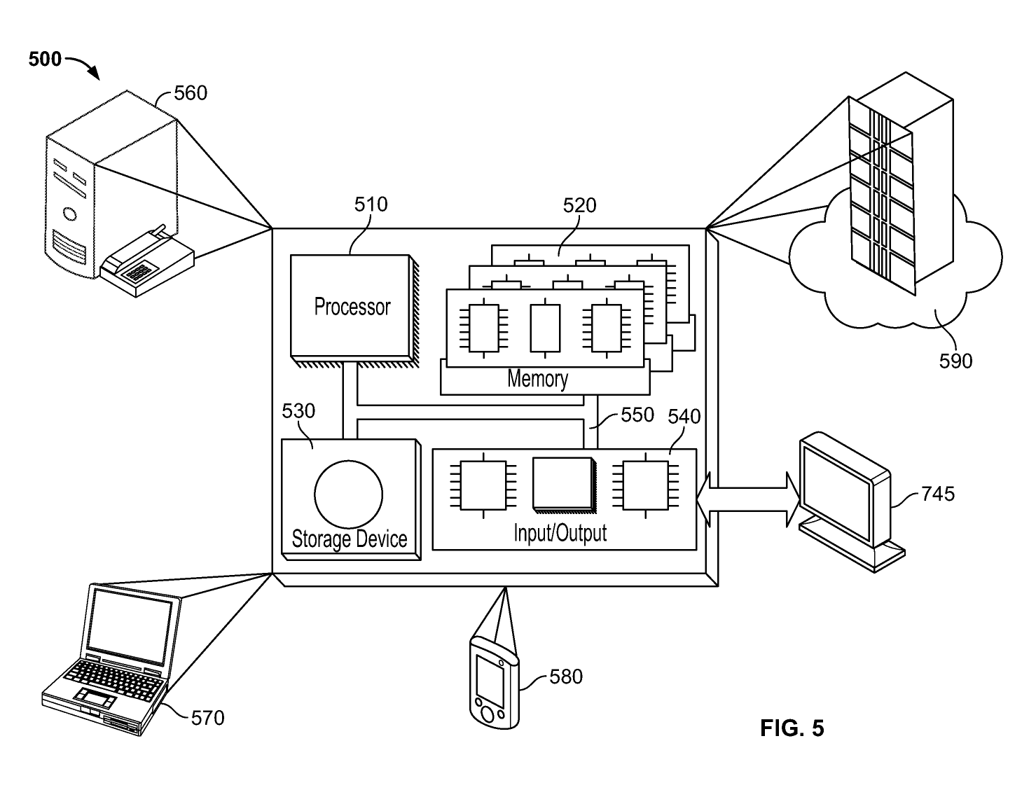

FIG. 5 shows a computer system 500 suitable for providing the CPU 105, the HDD 104 and RAM 106 of FIG. 1. The functionality described herein and shown in the Figures, including any functional blocks labeled as “processors” or “central processing units,” could be provided through the use of dedicated hardware as well as hardware capable of executing software in association with appropriate software. When provided by a processor, the functions could be provided by a single dedicated processor, a single shared processor, or a plurality of individual processors, some of which could be shared. Moreover, explicit use of the term “processor” or “controller” should not be construed to refer exclusively to hardware capable of executing software, and could implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, could also be included.

The computer system 500 could comprise a computer running any of a number of operating systems. The above-described methods could be implemented on the computer system 500 as stored program control instructions. Computer system 500 includes processor 510, memory 520, storage device 530, and input/output structure 540. One or more input/output devices could include a display 545. One or more busses 550 typically interconnect the components, 510, 520, 530, and 540. Processor 510 could be a single or multi core. Processor 510 executes instructions in which embodiments of the present disclosure could comprise steps described in one or more of the Figures. Such instructions could be stored in memory 520 or storage device 530. Data and/or information could be received and output using one or more input/output devices.

Memory 520 could store data and could be a computer-readable medium (e.g., volatile or non-volatile memory). Storage device 530 could provide storage for system 500 including for the previously described methods. Storage device 530 could be a flash memory device, a disk drive, an optical disk device, or a tape device employing magnetic, optical, or other recording technologies. Input/output structures 540 could provide input/output operations for system 500.

Input/output devices utilizing these structures could include, for example, keyboards, displays 545, pointing devices, and microphones, among others. As shown and could be readily appreciated by those skilled in the art, computer system 500 for use with the present disclosure could be implemented in a desktop computer package 560, a laptop computer 570, a hand-held computer, for example a tablet computer, personal digital assistant or Smartphone 580, or one or more server computers which could advantageously comprise a “cloud” computer 590.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this invention, but only by the claims that follow.

1. A system for combining recommendations, comprising:
a computer system in electronic communication over a network with a plurality of recommender systems; and
an optimization module stored on and executed by the computer system, the module:
receiving a recommendation request from a user over the network, the request relating to an item of interest to the user;
transmitting a request for a recommendation to each of the plurality of recommender systems;
receiving one or more recommendations and one or more ratings from each of the plurality of recommender systems;
processing the one or more recommendations and the one or more ratings to create an optimized list of recommended items, wherein each recommended item of the optimized list is calculated by the optimization module to maximize a probability that the item will be consumed by the user and a degree to which the item will be preferred by the user; and
transmitting the optimized list to the user over the network.

2. The system of claim 1, wherein the recommendation request identifies an item type and a number of items to be recommended.

3. The system of claim 2, wherein the item type is one of groceries, movies, television programs, printed publications, e-books, CDs, DVDs, retail goods, online goods, and entertainment content.

4. The system of claim 1, wherein the plurality of recommender systems include a consumed recommender system and a liked recommender system.

5. The system of claim 1, wherein the optimization module could identify particular recommender systems selected by the user.

6. The system of claim 1, wherein the engine processes a rule, constraint, or metric to promote certain items.

7. The system of claim 6, wherein the metric is maximizing revenue, maximizing sales, or maximizing profit per unit.

8. The system of claim 1, wherein the optimization module calculates for each recommender system a maximum score as a function of the retrieved ratings and a minimum score as a function of the maximum score and tradeoff factors, and wherein each item of the optimized list is calculated by the optimization module using the maximum score, minimum score, and tradeoff factors.

9. A method for combining recommendations, comprising:
electronically receiving at an optimization module, stored on and executed by a computer system, a recommendation request from a user over a network, the request relating to an item of interest to the user;
transmitting a request for recommendations to each of a plurality of recommender systems in electronic communication with the computer system over the network;
receiving one or more recommendations and one or more ratings from each of the plurality of recommender systems;
processing the one or more recommendations and the one or more ratings to create an optimized list of recommended items, wherein each recommended item of the optimized list is calculated by the optimization module to maximize a probability that the item will be consumed by the user and a degree to which the item will be preferred by the user; and
transmitting the optimized list to the user over the network.

10. The method of claim 9, wherein the recommendation request identifies an item type and a number of items to be recommended.

11. The method of claim 10, wherein the item type is one of groceries, movies, television programs, printed publications, e-books, CDs, DVDs, retail goods, online goods, and entertainment content.

12. The method of claim 9, wherein the plurality of recommender systems include a consumed recommender system and a liked recommender system.

13. The method of claim 9, further comprising identifying a selection by the user of particular recommender systems.

14. The method of claim 9, processing a rule, constraint, or metric to promote certain items.

15. The method of claim 14, wherein the metric is maximizing revenue, maximizing sales, or maximizing profit per unit.

16. The method of claim 9, further comprising calculating by the optimization module for each recommender system a maximum score as a function of the retrieved ratings and a minimum score as a function of the maximum score and tradeoff factors, and wherein each item of the optimized list is calculated by the optimization module using the maximum score, minimum score, and tradeoff factors.

17. A computer-readable medium having computer-readable instructions stored thereon which, when executed by a computer system, cause the computer system to perform the steps of:
electronically receiving at an optimization module, stored on and executed by the computer-readable medium, a recommendation request from a user over a network, the request relating to an item of interest to the user;
transmitting a request for recommendations to each of a plurality of recommender systems in electronic communication with the computer-readable medium over the network;
receiving one or more recommendations and one or more ratings from each of the plurality of recommender systems;
processing the one or more recommendations and the one or more ratings to create an optimized list of recommended items, wherein each recommended item of the optimized list is calculated by the optimization module to maximize a probability that the item will be consumed by the user and a degree to which the item will be preferred by the user; and
transmitting the optimized list to the user over the network.

18. The computer-readable medium of claim 17, wherein the recommendation request identifies an item type and a number of items to be recommended.

19. The computer-readable medium of claim 18, wherein the item type is one of groceries, movies, television programs, printed publications, e-books, CDs, DVDs, retail goods, online goods, and entertainment content.

20. The computer-readable medium of claim 17, wherein the plurality of recommender systems include a consumed recommender system and a liked recommender system.

21. The computer-readable medium of claim 17, further comprising identifying a selection by the user of particular recommender systems.

22. The computer-readable medium of claim 17, processing a rule, constraint, or metric to promote certain items.

23. The computer-readable medium of claim 22, wherein the metric is maximizing revenue, maximizing sales, or maximizing profit per unit.

24. The computer-readable medium of claim 17, further comprising calculating for each recommender system a maximum score as a function of the retrieved ratings and a minimum score as a function of the maximum score and tradeoff factors, and wherein each item of the optimized list is calculated by the optimization module using the maximum score, minimum score, and tradeoff factors.
